(19) United States
(12) Patent Application Publication
(10) Pub. No.: US 2013/0134269 A1
(43) Pub. Date: May 30, 2013

(54) SUPPORT FITTING FOR HEIGHT-ADJUSTABLE SUPPORT OF A SUBSTANTIALLY HORIZONTALLY EXTENDING BEARING AND GUIDING TRACK, AND TRACK SYSTEM THEREWITH

(71) Applicant: Michael Karl, Gauting (DE)

(72) Inventor: Michael Karl, Gauting (DE)

(73) Assignee: PANTHER GMBH, Oberhaching (DE)

(21) Appl. No.: 13/814,317

(22) PCT Filed: Aug. 5, 2011
(86) PCT No.: PCT/EP2011/003947

§ 371 Date: Feb. 5, 2013

(30) Foreign Application Priority Data
Aug. 5, 2010 (DE) 10 2010 033 533.9

(51) Int. Cl. G03B 17/56

(52) U.S. Cl. CPC G03B 17/561
USPC 248/157

(57) ABSTRACT

A support fitting is used for height-adjustable support of a substantially horizontally extending bearing and guiding track, for a camera trolley (dolly), and has a fitting body with an upper face, for directly or indirectly underpinning the track; and on a lower face lying opposite the upper face, receiving and/or fastening mechanism for fixing at least one support element, so the support fitting can be supported at a certain height with respect to a base. The fitting body can have at a stop member between the upper and lower face for connecting components that substantially extend below the contact surface (e.g. girders or sleepers). A number of variants are disclosed including one having a height-adjustable support for a substantially horizontally extending bearing and guiding track for supporting a camera trolley.

The present invention relates to a support fitting for height-adjustable support of a substantially horizontally extending bearing rail and/or guiding rail, in particular a rail for camera dolly, camera cranes, etc. and to a rail system consisting of two rails extending substantially equidistantly from each other with the use of a support fitting of this type.

Within the context of film shootings and telerecordings, camera movements are also realized, inter alia, with the assistance of what are referred to as camera dollies (camera trollies) and camera cranes. In order to be able to realize a smooth camera movement, such dollies or cranes are generally moved on rail systems in the event of an uneven underlying surface. In order, in the event of an uneven underlying surface, to be able to rapidly and flexibly lay and, in particular, level said rails, it is known to support the rails in a suitable manner with wedges, plates, crates or other aids. Said aids are optionally also placed on one another in combination with one another in order to bridge the particular height between the underlying surface and rail to even out the level.

Said mechanical aids for aligning and leveling the rails are designated as substructure.

Due to the frequently changing use locations (inside and outside regions) and the often demanding structural or natural conditions (for example stairs, cliffs, etc.), it is important for the rails or rail systems together with the particular substructure to be able to be constructed and dismantled individually, reliably and with little time being required. The safety of the substructure constitutes an essential factor, since sometimes very high loads of the order of magnitude of up to 2000 kg are moved on rails for camera dollies or camera cranes.

Accordingly, the components of the substructure have to be appropriately dimensioned, depending on requirements, i.e. have to be correspondingly large and/or stable, wherein, moreover, as many use locations as possible have to be covered by a combination of different sizes by the provision of different substructure parts.

It is therefore customary to provide a large number of such substructure parts of different sizes and shapes at shooting locations. When the shooting location is changed, said basic equipment has to be taken along in a complicated manner and constructed again individually at the new shooting location so as to correspond to the particular requirements, in order to be able to lay a rail in the desired manner.

This approach is therefore laborious and costly in terms of time and expense. In addition, the frequently necessary stability and safety of the substructure is only inadequately ensured.

If rails have to be laid at the shooting location, as a rough guide, up to 90% of these rails have to be supported since the underlying surface is as good as never completely even. To even out height differences, some of which may be a meter or more, a wide variety of parts having different dimensions from the basic substructure equipment have to be placed on one another in order to initially have a rough approximation or probing of the required leveling height. Remaining smaller residual distances are then evened out with wedges or plates of differing size and/or thickness.

Due to the time pressure which always prevails when shooting films, when laying the rails, due to lack of experience or inattentiveness accidents therefore repeatedly occur if the substructure of the rails does not withstand the loading of the dollies and cranes, since, because of the complexity and instability of the combination of different substructure parts (crates, plates, wedges etc.), in a very wide variety of underlying surfaces the substructure always constitutes a type of compromise or balancing act between the main requirements of stability and safety on the one hand, and efficiency in terms of time and expense, on the other hand.

It is known that considerable injuries to individuals occur time and again, since individuals (camera men and camera assistants etc.) are also moved on the rails together with the dollies or cranes.

GB 2 274 820 A has disclosed a rail system for camera dollies, in which, instead of a structurally frequently dubious substructure consisting of crates or the like, a metal framework bears the rail system. The rail system itself consists of two rails which extend at a distance from and parallel to each other and have a round cross section and on which the dolly (the crane etc.) rolls by means of a correspondingly configured bogie truck. The rails rest with the assistance of corresponding bearing or bearer elements on ties or cross beams which project on both sides laterally over the track or rail system formed on the two rails. Supporting legs arranged vertically, i.e. substantially perpendicularly to the course of the rails, are attached in said laterally projecting regions of the cross beams or ties, wherein each of said supporting legs is telescopic in a manner following a grid system and, at the lower, free end thereof, has a bearing plate which is adjustable via a threaded spindle. In each case two such supporting legs and a cross beam or tie extending horizontally therebetween form a support for underpinning the rails, wherein the tip, in each case because the supporting legs thereof are telescopic in a manner following a grid system, is first of all height-adjustable and able to be leveled roughly and then finely by adjusting a spindle.

In order to obtain greater stability, the two supporting legs of a supporting element among themselves and optionally supporting elements adjacent to one another in the direction in which the rail extends, are supported and reinforced in relation to one another by additional struts or bracings.

In practice, the subject matter of GB 2 274 820 means that substructures constructed from different aids in situ together with the associated logistical and safety problems can be omitted since the entire substructure is constructed from standard support elements which, depending on the local conditions can be correspondingly roughly adjusted and then finely adjusted (i.e. height adjusted) in order to be able to support and level the rails at a desired height and/or in a desired alignment. The components forming the individual support elements are in this case standardized as far as possible, and therefore it is no longer necessary to have to take along extensive basic equipment of differently dimensioned and configured auxiliary structural elements (crates, plates, wedges etc.).

In this respect, the subject matter of GB 2 274 820 provides an increase in respect of efficiency, saving on expense and enhanced safety in relation to the previous approach.

A disadvantage of the subject matter of GB 2 274 820 is that the cross beams or ties extending between the two rails of the track, in addition to their function of holding the two rails parallel to each other and at the same distance from each other, at the same time carry out the bearing function between substructure and rails: the two supporting legs are attached to the cross beam sections which project on both sides beyond the outer boundary line of the rails. The two rails each rest offset further inward on the upper side of the respective cross beam, and therefore, in the event of a weight-loading of the rails, said weight-loading is transmitted to the tie located therebelow. As a result of the fact that the supporting legs lie outside the rail, the weight-loading causes the tie to be deflected if said tie is not designed in a sufficiently stable and therefore flexurally rigid manner.

Furthermore, the fastening between the tie and supporting leg has to absorb a torque-loading.

Since the tie has to be constructed to be sufficiently flexurally rigid so that the weight-loadings which occur can be reliably absorbed by the tie and transmitted to the supporting legs without noticeably deflecting the tie in the process, the outlay on material and expense for producing the ties is increased. Furthermore, the ties are disadvantageously heavy and are therefore correspondingly more awkward to handle and to transport. Finally, the heavy ties disadvantageously contribute to an overall weight-loading of the substructure.

Rail systems for camera dollies are also known from the following documents: DE 10 2007 014 944 A1, WO 2007/145542 A1, US 2005/0231689 A1, DE 20 2004 007 518 U1 and U.S. Pat. No. 3,598,355. Other rail systems are known from the following documents: U.S. Pat. No. 3,261,550, U.S. Pat. No. 4,607,574 and DE 93 16 317 U1. Finally, the following documents: DE 1 855 542, DE 801 537 and DE 810 428 show crash systems.

By contrast, the present invention has made it the object to design a support fitting of the type in question in such a manner that easier operation and a saving on weight are achieved while improving the stability and therefore safety in relation to the solution known from GB 2 274 820 A.

In order to achieve this object, the present invention proposes, according to claim 1, a support fitting for height-adjustable support of a substantially horizontally extending bearing and guiding rail, in particular rail for camera dollies or the like, wherein the support fitting has a fitting body which, for its part, in the region of a side defined as the upper side, has a bearing surface for directly or indirectly underpinning the rail. The fitting body furthermore, on a side which is defined as the lower side and is opposite the upper side, has receiving and/or fastening means for fixing at least one support element, with which the support fitting can be supported at a certain height in relation to a base.

Accordingly, in the case of the subject matter of the present invention, the support fitting by means of the support body thereof constitutes a functional junction which combines a plurality of structural functions in itself, namely the support (directly or indirectly, wherein the statement behind “directly” and “indirectly” is explained below) of the rail by underpinning the rail with the bearing surface on the upper side, the support of the fitting body itself and therefore of the rail resting thereon by the at least one support element which are arranged on the receiving and/or fastening means opposite the upper side, wherein said support elements permit a support at a certain height.

Within the context of the present invention, by a “direct” underpinning of the rail with the bearing surface on the fitting body it should be understood that the rail is inherently stable and self-supporting, for example is present in the form of an appropriately surface-treated steel tube having a generally round cross section. Rails of this type can be sufficiently inherently stable in contrast to rails consisting of light metal or the like which, in order to obtain the required inherent stability and rigidity, require what is referred to as a bearer which adequately reinforces the actual rail body. In the event of an “indirect” underpinning of the rail by the bearing surface, said underpinning takes place by arranging the bearer between the rail and bearing surface, i.e. it is the bearer which comes to lie on the bearing surface.

The receiving and/or fastening means for fixing at least one support element are/is arranged or formed on the fitting body opposite the upper side. This means that the support element acts directly on the fitting body and not on a cross beam or tie extending between two rails, i.e., in the case of the subject matter of the present invention, said cross beams or ties only have to carry out the function as spaces between the two rails extending parallel and equidistantly. They do not take on any bearing function whatsoever and, in particular, do not have to absorb any weight-loadings acting on the rails from a dolly or camera crane or the like and dissipate said weight-loadings to the support element or the support elements. Consequently the cross beams or ties can be optimized in terms of material and dimensioning exclusively in respect of the spacer function thereof, i.e., in particular, can be designed to be more slender and therefore lighter and also more cost-effective. Ultimately, this means a saving on expense and weight in relation to the prior art. Furthermore, the support fitting according to the invention provides increased stability and therefore safety and also easier operation (space needed for transportation and in the assembled state).

The present invention furthermore relates, according to claim 2, to a support fitting for height-adjustable support of a substantially horizontally extending bearing and guiding rail, in particular rail for a camera dolly or the like, with a fitting body which, on a lower side, has receiving and/or fastening means for fixing at least one support element, with which the support fitting can be supported at a certain height in relation to a base, wherein the rail, for reinforcement purposes, has a bearer, to which the support fitting is fastened or fastenable outside a vertical plane of the rail.

The fitting body preferably has at least one stop means between the upper and lower side for connecting components extending below the bearing surface.

The following further structural function is therefore integrated in the fitting body: it is possible for, for example, cross beams or ties which substantially extend below the bearing surfaces to be attached laterally to the fitting body. Since, in this exemplary embodiment, the fitting body is again fastened directly or else indirectly to the rail or to the rails, the rails are thereby arranged equidistantly and parallel.

In the event of directly underpinning the rail, the bearing surface is preferably matched to at least one partial region of the rail circumferential contour for surface contact therewith. A first positional fixing of the rail in relation to the bearing surface is thereby obtained with structurally simple means.

Correspondingly, in the event of indirectly underpinning the rail, the bearing surface is preferably matched to at least one partial region of the bearer of the rail for surface contact therewith.

Provision is preferably made according to the invention for the lower side of the receiving and/or fastening means to lie above the lower side of the rail, a bearer of the rail and/or a tie or to be aligned with the lower side of one of the elements mentioned. This ensures that the minimum possible height of the rail upper edge is not impaired by the receiving and/or fastening means. This is because if they protrude beyond, for example, the lower side of the bearer of the rail, the rail system can no longer be placed with the lower side of the bearer onto the ground.

The longitudinal axis of the receiving and/or fastening means for the at least one support element preferably substantially extends through the center of gravity of the area of the bearing surface. This means, in practice, that, in particular when directly underpinning the rail, but, in the majority of cases, also in the event of indirect underpinning with the interconnection of a bearer, the center of gravity of the area of the rail cross section, the center of gravity of the area of the bearing surface and the longitudinal axis of the receiving and/or fastening means lie substantially aligned in a line. In the ideal case, force exerted by the weight of a dolly or camera dolly rolling on the rail is therefore introduced vertically downward through the center of gravity of the area of the bearing surface into the longitudinal axis of the receiving and/or fastening means, i.e. without lateral force components which can cause buckling moments in the fastening means or the support element. It is thereby possible reliably to support even relatively great loads.

The receiving and/or fastening means for fixing the at least one support element are preferably designed as a socket on the fitting body. A plug part which is of complementary design to the socket, on the part of the support element is inserted into the socket and connected to the fitting body. In this case, the support element is arrangeable in the socket in such a manner that the longitudinal axis of said support element is substantially perpendicular to the bearing surface. This constitutes an embodiment which is simple to handle and is functionally reliable in practice.

In this case, clamping means are preferably provided on the socket and can be used to firmly clamp the support element or the plug-in part thereof in the socket. This firstly constitutes a positional securing of the support element in relation to the socket and secondly affords the possibility of undertaking fine adjustment or leveling of the entire line in the region of the socket, as will also be explained in more detail below.

In order, in this case, to arrive at a particularly durable fixing, it is preferred if the socket has/have encircling grooves. An additional form-fitting connection can therefore be produced during the clamping.

If the socket has a flap section which is fastened in a hinged manner to the socket via a hinge, the support element can be inserted laterally into the socket. The flap section can subsequently be swung shut and locked, and therefore the support element is fixed in the support fitting according to the invention. In this case, a pivot axis of the hinge is preferably aligned perpendicularly to the rails.

As an alternative to the clamping technique a threaded connection can be provided, in which the support element is screwable into the fastening means via a threaded section. The height adjustment of the support fitting according to the invention is therefore also carried out via the threaded connection.

The stop means for the connecting components substantially extending in the same plane as the bearing surface are preferably fastening flanges and/or fastening holes. In this connection, at least three stop means are provided, wherein two of said stop means lie in a plane aligned with a longitudinal axis of the bearing surface and the third stop means is at a right angle thereto. The two stop means which are aligned with the longitudinal axis of the bearing surface therefore extend in the direction of extension of the rail and point in said direction of extension, and the third stop means which is at a right angle thereto, can preferably be used for the mounting of a cross beam or tie extending between the rails. Rail bearers for the direct underpinning of a rail, or other reinforcing means or aids can be fastened to the two stop means aligned with the longitudinal axis of the bearing surface.

The present invention finally relates to a rail system, in particular for a camera dolly, camera crane or the like, formed from two rails which extend substantially equidistantly from each other and the distance between which is adjusted and maintained by ties extending therebetween, wherein a support fitting according to the present invention is preferably arranged at the connecting point between rail and tie.

Further details, aspects and advantages of the present invention are better apparent from the description below with reference to the drawing, in which:

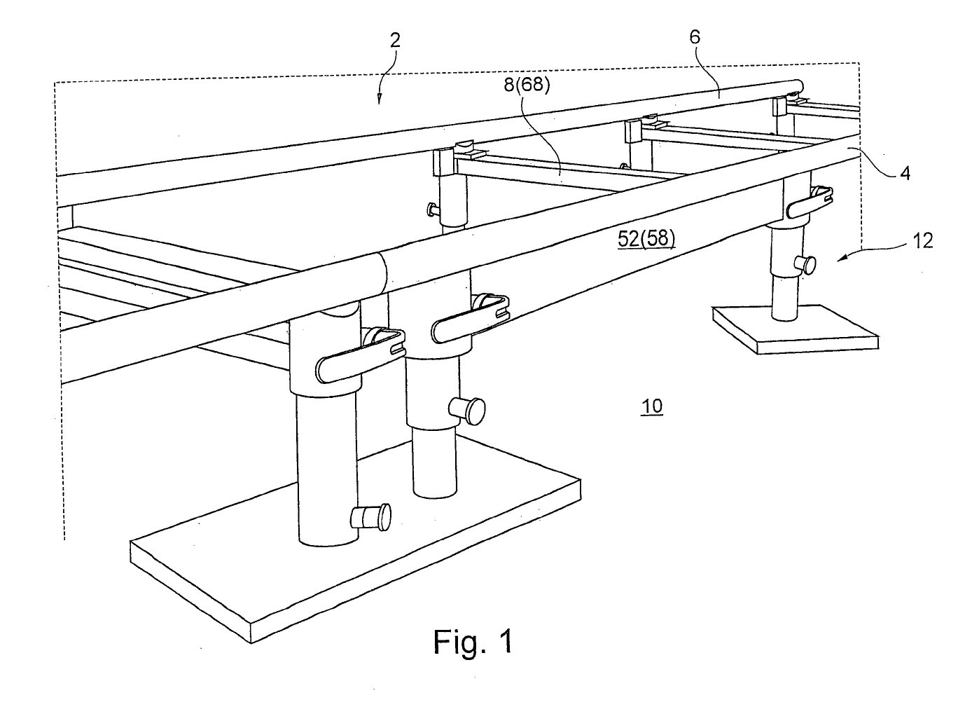

FIG. 1 shows a perspective view of a detail of a rail system which is constructed using two rails, a plurality of support fittings and cross beams or ties running therebetween;

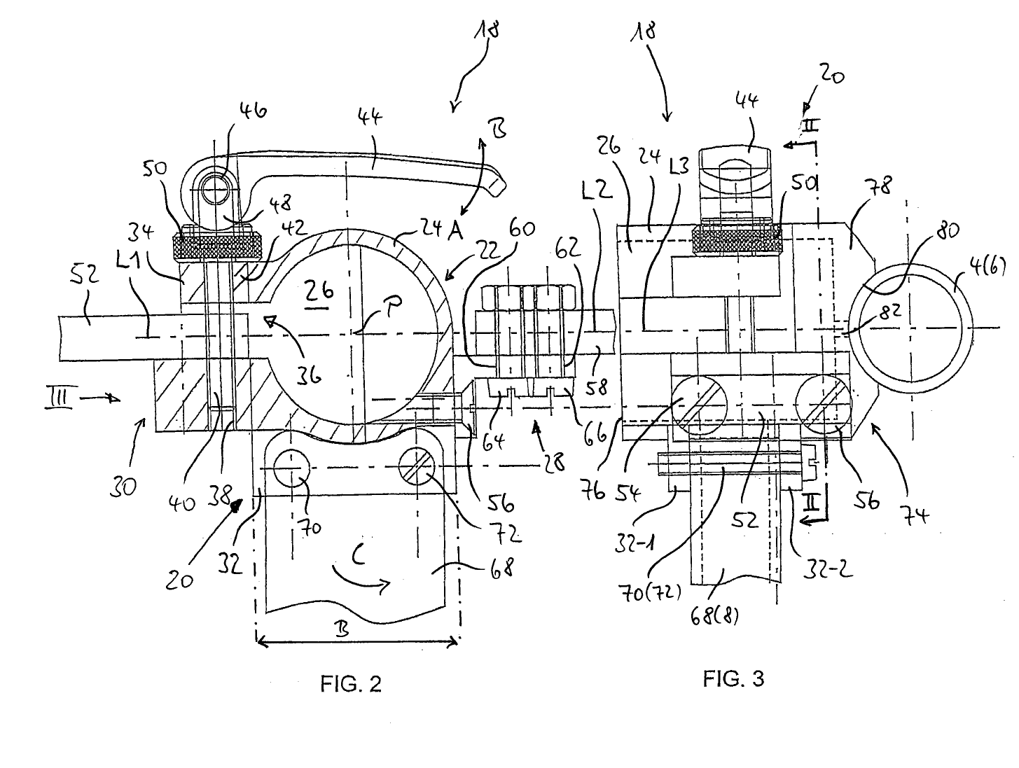

FIG. 2 shows a sectional view along line II-II in FIG. 3 of the support fitting or fitting body according to the present invention with components which are attached to stop means and are indicated schematically;

FIG. 3 shows a view of the support fitting or fitting body according to the invention in the direction of the arrow III in FIG. 2;

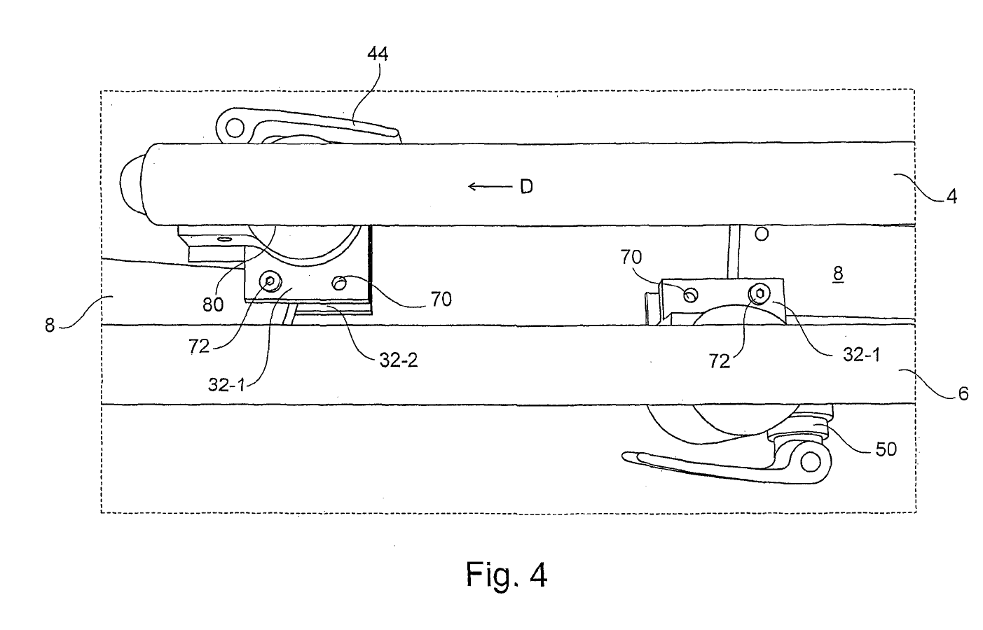

FIG. 4 shows a top view of two rails with support fittings attached thereto and cross beams or ties running therebetween, in a folded state;

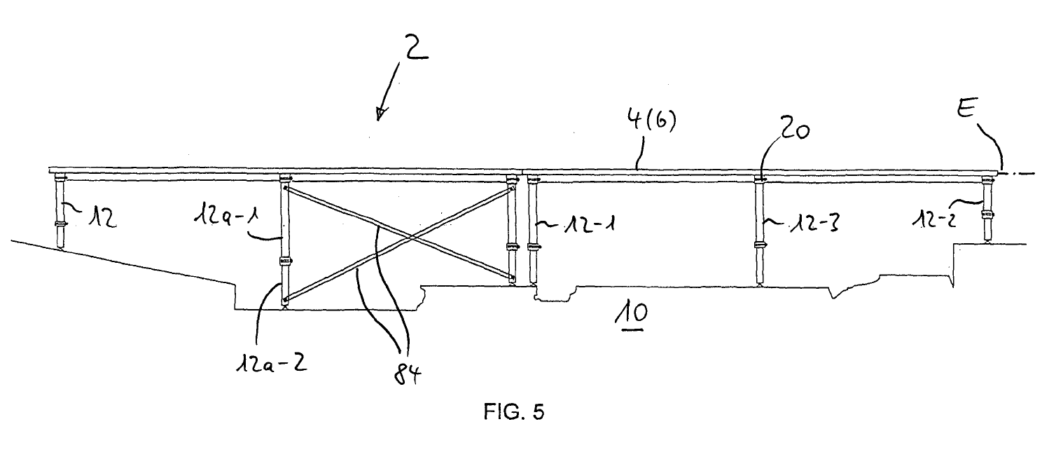

FIG. 5 shows a schematic side view of a line;

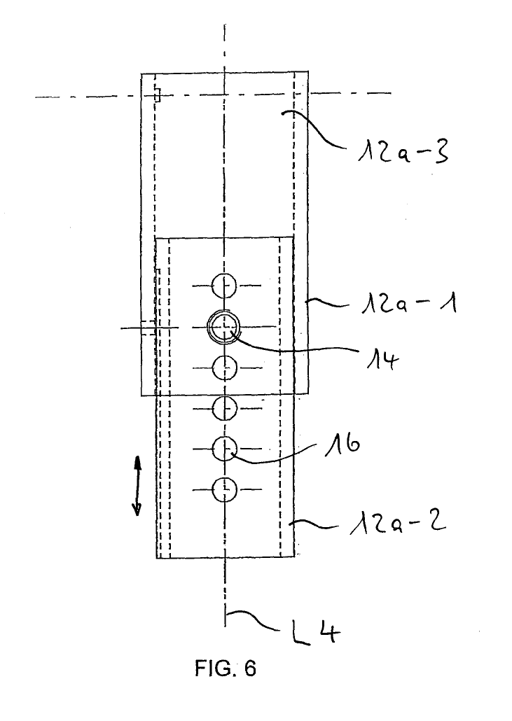

FIG. 6 shows a schematic illustration of a support element, which is designed as a telescopic supporting leg, for use in the present invention;

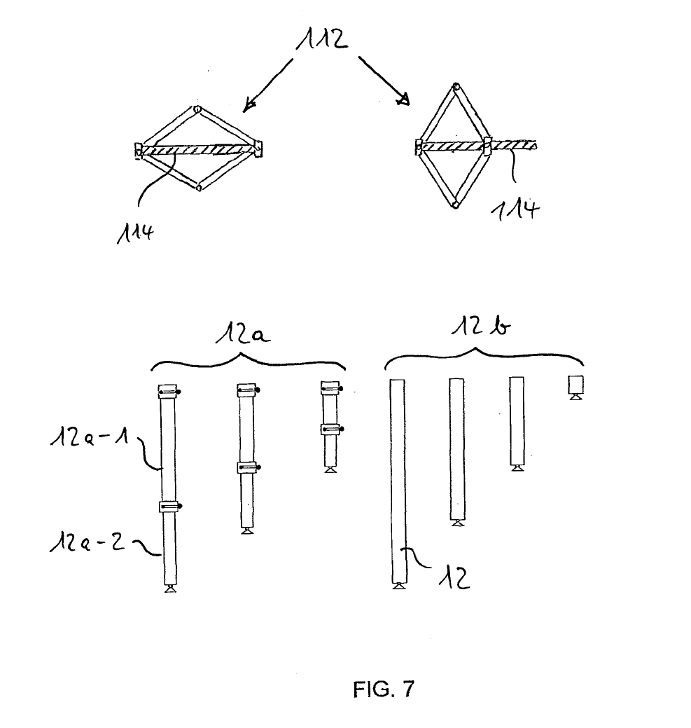

FIG. 7 shows examples of support elements usable in the present invention, and

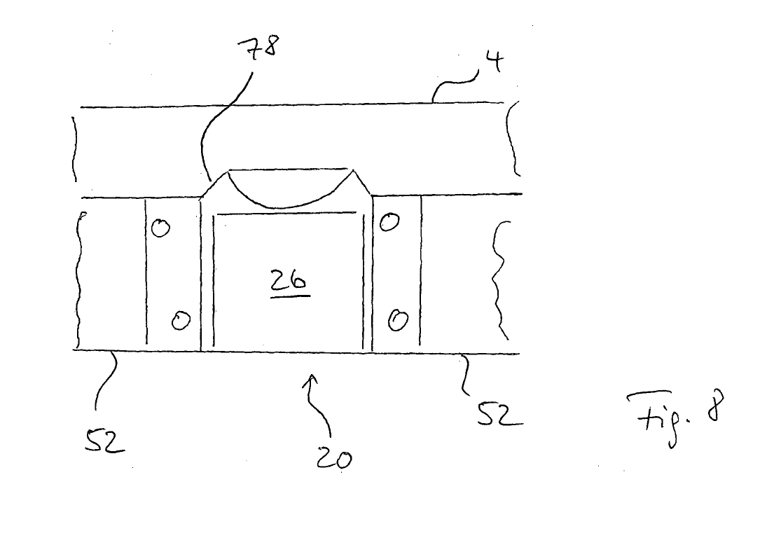

FIG. 8 shows schematically a further exemplary embodiment of the invention.

The individual figures of the graphical illustration are not to scale with one another (with the exception of FIGS. 2 and 3). Furthermore, the subject matter of the present invention is not restricted to the embodiments specifically graphically illustrated, since the drawing should be understood as purely illustrative and explaining the basic concept of the present invention and as not restricting the latter.

Furthermore, in the description below, a differentiation will be made between “rail” and “track” or “rail system”: a single rail body should be understood by “rail”. In order to form a “track” or “rail system”, two such rails should be arranged at a distance from each other and extending parallel to each other, wherein cross beams or ties are arranged between the two rails in order to maintain distance and parallelism.

FIG. 1 shows a perspective illustration of such a rail system or track 2, which is formed from two rails 4 and 6 which are arranged so as to extend parallel to one another at a certain distance. Cross beams or spacers, called ‘ties’ hereinbelow, which are provided with the reference sign 8, are provided between the rails 4 and 6 in order to maintain distance and parallelism.

The description below relates to one of the two rails 4 and 6, namely the rail 4; the statements made in this respect relate in an equivalent manner also to the rail 6 unless stated otherwise.

In the exemplary embodiment illustrated, the rail 4 is designed in the form of a steel tube having a round cross section. The round cross-sectional shape or a partial section of the outer circumference of the rail 4 defines a running surface on which correspondingly designed casters of a camera dolly, camera crane or the like run. The technologies used in this respect are documented in detail and are known and, since they in particular do not contribute anything substantial to the subject matter of the present invention, a more detailed explanation of said technologies is omitted.

As already explained at the beginning, it is essential, when laying the track 2, that, in addition to the parallelism and constant spacing of the rails 4 and 6, corresponding leveling also takes place insofar as the track 2 has a continuously even course along a plane E in relation to an underlying surface 10 (FIG. 5). In this connection, the plane E may lie horizontally, i.e. “in the water”, or it may show a slight rise or a slight drop. In every case, when erecting the track 2, care should be taken to ensure that the two rails 4 and 6 are correspondingly leveled, i.e. aligned, in relation to the underlying surface 10, so that a camera dolly running on the rails 4 and 6 can move gently, i.e. without jolting and with little effort, in order to permit accurate camera tracking shots. In addition, the rails which lie against each other on the end sides have to lie in a plane.

In order to obtain such an alignment or leveling, the track 2 is supported in relation to the underlying surface 10 by a plurality of support elements 12 of different length, as again best emerges from FIGS. 1 and 5. In the exemplary embodiment illustrated, the support elements 12 are tubular supporting legs which, in order to obtain the necessary leveling of the track 2, are either telescopic (12a in FIG. 7) or are of a constant, but differently dimensioned length (12b in FIG. 7). Furthermore, combinations of the embodiment options 12a and 12b are possible.

FIG. 5 shows how different support elements 12 of differing overall length and with a differing degree of telescoping can be used for matching the track 2 to the irregularly contoured underlying surface 10.

A telescopic support element 12a is illustrated schematically in FIG. 6 and comprises an outer tube 12a-1 and an inner tube 12a-2 accommodated slideably in the latter. The outer wall of the outer tube 12a-1 has at least one opening 14 and the outer wall of the inner tube 12a-2 has a plurality of openings 16. By one of the openings 16 in the inner tube 12a-2 being brought into alignment with the opening 14 in the outer tube 12a-1 and a bolt or the like being pushed through the two openings 14 and 16, plug-in amounts of differing depth of the inner tube 12a-2 in the outer tube 12a-1 can be selected and fixed. As a result and optionally in conjunction with outer tubes and inner tubes formed with differing lengths, a comparatively large length region for the support elements 12 can be covered, depending on the type of kit, in a grid system corresponding to the distance between the openings 16. By means of said grid-system-like length adjustability of the individual support elements 12, at least one rough alignment or basic leveling of the track 2 in relation to the underlying surface 10 is possible. For fine alignment or final leveling of the track 2, the support fitting 18 according to the invention also has a fine adjustment option, which will be discussed in more detail below.

The support fitting 18 according to the invention or the fitting body 20 thereof will be discussed in more detail below in particular with reference to the FIGS. 2 and 3.

The fitting body 20 is preferably manufactured from one piece by appropriate machining and substantially comprises a central block 22 which is substantially designed in the form of a sleeve which, in the view according to FIG. 2, is bounded by a wall section 24 which runs in the shape of a circular arc and, in the interior thereof, defines a hollow cylindrical socket 26. The socket 26 serves for receiving an upper end section 12a-3 of the outer tube 12a-1 according to FIG. 6, i.e. the inside diameter of the socket 26 substantially corresponds to the outside diameter of the upper end section 12a-3.

According to FIGS. 2 and 3, stop means protrude radially from the outer circumference of the wall section 24, namely, in the view and terminology of FIG. 2, a right stop means 28, a left stop means 30 and a lower stop means 32 which is in each case at a right angle thereto. It should be expressly emphasized that the terms “right”, “left” and “at the bottom” relate solely to the graphical illustration of FIG. 2 and not to a specific installation position of the fitting body 20.

Opposite the left stop means 30, a flange 34 is formed emerging from the wall section 24, wherein the wall section 24 between the flange 34 and the stop means 30 is interrupted in the manner apparent from FIG. 2 by a slot or a cutout 36.

In the region of the left stop means 30, a threaded bolt 40 is screwed into a threaded bore 38 there, said threaded bolt passing on the part of the flange 34 with a clearance through a bore 42 there. A lever 44 is provided at the free end of the bolt 40 in the region of the bore 42, said lever being connected pivotably to the free end of the bolt 40 via an eccentric bore 46. The lever 44 has a section 48 which is of spherical design and, with the interconnection of a friction disk 50, presses against the outer surface of the flange 34.

Owing to the spherical design of the section 48 and the eccentric mounting of the lever 44 at the bore 46, during a pivoting movement of the lever 44 in the direction of the arrow A in FIG. 2, a corresponding tensioning movement takes place, the tensioning movement being applied to the bolt 40. Since the bolt 40 on the part of the left stop means 30 is screwed in an axially immovable manner into the threaded bore 38 there, said tensioning movement causes a movement of the flange 34 toward the left stop means 30 or away therefrom, wherein the gap 36 is correspondingly reduced or increased. By this means, the inner circumference of the wall section 24 can be pressed against the outer circumference of the upper end section 12a-3 of the outer tube 12a-1, and therefore the upper end section 12a-3 can be clamped in the socket 26 and therefore fixed in position. A movement of the lever 44 in the direction of the arrow B in FIG. 2 causes the releasing movement between flange 34 and left stop means 30, and therefore the slot 36 is widened because of the elasticity inherent in the material and the inner circumference of the wall section 24 opens up the outer circumference of the upper end section 12a-3 at least to an extent such that the outer tube 12a-1 can be displaced in relation to the socket 26 and therefore in relation to the support fitting 18, and can be pulled completely out of the socket 26 or can be introduced into the latter.

The top view of FIG. 2 illustrates a component 52 which is fastenable in the region of the left stop means 30 in FIG. 2 to said stop means. For this purpose, the left stop part 30 has one or more bores (lying outside the sectional plane of FIG. 2) into which screws are screwable. In addition or alternatively, fixing pins may also be used.

The right stop means 28 in FIG. 2 serves in analogous manner to fasten a further component 58 to the stop body 20. For this purpose, the right stop means 28 has bores 60 and 62 into which screws 64 and 66 are screwable, wherein, as shown in FIG. 2, the components 52 and 58 are arranged in such a manner that said components are aligned with each other, i.e., in the event of elongate design of the components 52 and 58, the longitudinal center lines or longitudinal center planes L1 and L2 thereof lie on a common plane or line which runs through the center point of the circular cross section of the socket 26.

The components 52 and 58 may belong, for example, to a rail bearer, i.e. a bearing component which is located below a rail 4 or 6 if said rail is manufactured from a material and/or is dimensioned in such a manner that it is not self-supporting in the sense of absorbing the load by itself. By fastening the rail bearers in the form of the components 52 and 58 to the fitting body 20, the forces absorbed by the components 52 and 58, which are/may be parts of the bearer, are transmitted via the stop means 28 and 30 to the fitting body 20, and therefore to the respective support element 12 which is accommodated in the socket 26.

The rails 4, 6 may also each be formed integrally with the components/bearers 52 and 58 respectively.

The lower stop means 32 in FIG. 2 is likewise designed in the form of a flange and serves for fastening a further component 68. The component 68 is fastened via screws 70 and 72 which are screwed into corresponding bores of the stop means 32 and of the component 68. According to FIG. 3, in this case the lower stop means 32 is preferably designed in the form of a double flange, wherein a lower flange part 32-1 and an upper flange part 32-2 accommodate an end section of the component 68 between them. The screws 70 and 72 then pass from above first of all through the upper flange part 32-2, then through the component 68 and finally through the lower flange part 32-1.

According to a further preferred embodiment, the component 68 can also be fastened to the lower stop means 32 in such a manner that, according to FIG. 2, only one screw (screw 72) passes through the two flange parts 32-1 and 32-2 and the component 68.

The resultant advantages are explained in more detail below.

FIG. 3 shows a view of the fitting body 20 in the direction of the arrow III in FIG. 2. The installed position of the fitting body 20 corresponds in practice to a position which is obtained upon rotation of the illustration of FIG. 3 through 90 degrees counterclockwise such that the lever 44 comes to lie on the left and the component 68 on the right. In this position, a side of the fitting body 20 that is defined as the upper side 74 and a side thereof that is defined as the lower side 76 is provided, wherein the stop means 28, 30 and 32 are located between the upper side 74 and lower side 76 in a manner spaced apart from each other in the circumferential direction. The lever 44 is likewise located on that circumferential side of the fitting body 20 which is opposite the stop means 32.

In the region of the upper side 74 of the fitting body 20, an end wall 78 closes the socket 26. A bearing surface 80 the shape of which is matched at least to a partial region of the circumferential contour of the rail 4 or 6 for surface contact therewith, is defined in the region of the end wall 78. In the exemplary embodiment of the figures with a circular cross section of the rails 4 or 6, this means that the bearing surface 80 is in the shape of an elongated trough with two open end sides and a bottom in the shape of a segment of a circle. The two open end sides open to the left and right in FIG. 2 such that the bearing surface 80 has an elongated shape, the length extent of which in FIG. 2 corresponds to a width B of the stop means 32. The lowest point of the bearing surface 80 in the cross section coincides with the center point of the circular cross section of the rail 4 or 6 and with the center point P of the circular cross section of the socket 26. A longitudinal axis L3 of the support fitting 18 therefore substantially extends through the center of gravity of the area of the bearing surface 80.

The end wall 78 may constitute an abutment for the bearing on the support 12.

One or more fastening bores 82, with which the rail 4 or 6 is fixable to the bearing surface 80 by a screw connection introduced from the socket 26, can be formed in the region of the end wall 78.

In order to connect the fitting body 20 to the rail 4 or 6, the rail 4 is placed onto the bearing surface 80 and is screwed to the fitting body 20 via the bore or the bores 82. If, in this case, the rail 4 or 6 additionally has a bearer, said bearer is screwed on one side to the right stop means 28 via the screws 64 or 66 and a further bearing is screwed to the stop means 30 via screws.

The component 68 which is arranged as a cross beam or tie between two rails 4 and 6 extending parallel to each other extends to an adjacent fitting body 20 which bears the second rail of the pair of rails forming the track 2.

As shown in FIG. 1, a plurality of fitting bodies 20 is therefore screwed continuously at the respectively necessary distances to the respective rails. The components 68 or ties 8 are arranged between the individual fitting bodies 20.

The support elements 12 or the upper end sections 12a-3 thereof are introduced into the respective fitting bodies 20 or the sockets 26 thereof from below, and therefore the rails 4 and 6 of the rail system or track 2 can be supported in relation to the underlying surface 10.

Owing to the fact that, according to FIGS. 5, 6 and 7, support elements 12 of differing basic lengths and/or with a telescoping amount of differing size can be connected, when required, to the respective fitting bodies 20 or the sockets 26 thereof, it is possible, for example according to FIG. 5, for matching to extremely different profiles of the underlying surface 10 to be undertaken in such a manner that the track 2 remains aligned in the plane E.

At least a rough matching or rough leveling of the track 2 can be undertaken by selecting support elements 12 of differing lengths, according to FIG. 7, and/or by differing telescopic amounts between the outer tube 12a-1 and inner tube 12a-2. A fine matching or fine leveling of the track 2 is then undertaken by individual displacement of the upper end sections 12a-3 in the interior of the respective sockets 26 with the lever 44 released. If the required relative position between upper end section 12a-3 and socket 26 is reached, the lever 44 is brought into its clamping position according to FIG. 2, and therefore the upper end section 12a-3 is fixed in relation to the socket 26.

It is thereby possible to obtain a precise and rapid alignment of the track 2 in relation to the underlying surface 10. In the event of a self-supporting rail system which, when unloaded, shows substantially no sag, the fine leveling can be achieved by the fact that, for example according to FIG. 5, two of the support elements (support elements 12-1 and 12-2) are adjusted and aligned in such a manner that the associated track section is aligned exactly. The remaining support element 12-3 (or further support elements located between the support elements 12-1 and 12-2) are then selected from the basic equipment after rough measurement (FIG. 7) and/or are adjusted in a telescoping manner and introduced into the socket 26 of the associated fitting body 20. The support element 12-3 then drops downward under the effect of gravity, with simultaneous displacement of the upper end section 12a-3 in the socket 26, until the lower, free end of said support element touches the underlying surface 10. In this position of the support element 12-3, the lever 44 is brought into the clamping or tensioning position thereof.

FIG. 5 furthermore shows that, when required, reinforcing cross beams 84 can be laid between individual support elements 12. Under some circumstances, cross beams of this type may also be inserted in a diagonally extending manner between mutually adjacent support elements 12 if the components 68 or ties 8 cannot ensure sufficient stability between the rails 4 and 6.

In the embodiment option discussed further above, in which the component 68, i.e. the tie 8, is fastened to the flange-like stop means 32 only by one screw (screw 72), the tie 8 can be pivoted in relation to the fitting body 20. By this means, it is possible to bring the two rails 4 and 6 according to FIG. 4 into a tightly adjacent alignment with respect to each other, by pivoting the ties 8 located between said rails, thus simplifying transportation and storage of the rail system 2.

For erection in situ rails 4 and 6 are brought to the correct distance from each other by ties 8 pivoting about the screw 72 until alignment has been obtained in the region of the free passage bores between the two flange parts 32-1 and 32-2 and the ties 8. In the illustration of FIG. 4, this would mean a movement of the rail 4 in the direction of the arrow D relative to the rail 6. The tie 8 pivots in this case about the screw 72. Analogously, the right tie 8 in FIG. 4 pivots about the screw 72. In the end position, the two rails 2 and 4 are at the correct distance, wherein said distance and the parallelism of the rails 2 and 4 is maintained by the ties 8 serving as pure spacers.

In the following, the required support elements 12 are introduced into the sockets 26 of the fitting bodies 20 and adjusted in order to level the track 2.

In the case of the subject matter of the present invention, force is transmitted by the rails 4 and 6 preferably, but not exclusively, directly to the support elements 12 located therebelow, since the longitudinal axis (L4 in FIG. 6) of the support elements 12 substantially extends through the center of gravity of the area of the bearing surface 80. Therefore, in the event of loading of the rails 4 and 6, the ties 8 are not exposed to any bending torques whatsoever, and therefore the ties 8 can carry out a pure spacer function. By this means, it is possible to configure the ties 8 to be correspondingly lightweight and/or to dimension them such that the entire rail system consisting of the two rails 4 and 6 and a number of ties 8 extending therebetween becomes correspondingly light and more reasonably priced. Since the ties 8 do not have to absorb any bending torques and do not belong to the weight-bearing construction of the rail system 2, it is possible also to design the ties 8 to be telescopic (optionally in steps on a grid system) such that the distance between the two rails 4 and 6 is adjustable in a stepwise manner in order therefore to change the gauge of the rail system. On account of the non-bearing function of the ties 8, the adjustment means belonging thereto can be configured to be correspondingly simple and reasonably priced.

With the embodiment in which the fitting body has at least one stop means between upper and lower side for connecting components substantially extending in the same plane as the rail; and the fitting body is fixable directly or indirectly to the rail outside a vertical plane thereof, substantially the same advantages as in the above-described embodiment can be obtained. The essential difference consists in that the fitting body does not lie directly below the rail or the bearer in such a manner that the longitudinal axis of the support means is aligned with the vertical plane of the rail/of the bearer. On the contrary, the fitting body lies outside said plane, and therefore the center point P lies outside the longitudinal center plane L1 or L2, i.e. in FIG. 2, is displaced, for example, in the direction of the lever 44, i.e. in the direction of the outside of the subsequent rail system 2. The fitting body is therefore fastened laterally to the rail or the bearer, and the force of weights acting on the rails 4 and 6 is introduced or transmitted via the socket 26, which lies to the side of the rail/the bearer to the support element without participation of a cross beam or tie 8, and therefore there is essentially no change to the advantages obtainable with the present invention. To this extent, the statements made above with reference to the first exemplary embodiment apply equally to the second exemplary embodiment; a transfer of the features in their entirety from the written and graphical disclosure—if this appears appropriate in terms of technical aspects—of the first exemplary embodiment to the second is hereby expressly declared in order to avoid unnecessary repetitions.

In the preferred embodiment described, the support fittings 18 or fitting bodies 20 functionally constitute junctions where all of the forces acting on the rail system 2 converge and are dissipated to the support elements 12 located vertically therebelow. This permits a high degree of functionality, paired with stability, safety and exact leveling capability.

The formation of the support elements 12 in the form of telescopic tubes constitutes a preferred embodiment for reasons of expense and weight. However, other embodiment options are also conceivable, for example an infinitely variably operating screw adjustment between outer tube 12a-1 and inner tube 12a-2. It is likewise possible, instead of a tubular configuration of the support element 12, to use a scissors-type lifting mechanism 112 with a spindle 114 according to FIG. 7.

FIG. 8 schematically shows a partial view of a further exemplary embodiment of the invention. According thereto, the lower side of the fitting body 20 bounding the socket 26 is aligned with the lower side of bearers 52, 52. If a support 12 is not plugged into the socket 26, the rail system can rest on the ground with the lower side of the bearers 52 without the fitting body 20 being disturbed. As a result, an arrangement of the rail system at a minimum height is possible. The end wall 78 constituting an abutment should lie as close as possible below the upper side of the rail, which has advantages in respect of absorption of torque and, moreover, opens up the possibility of mounting short, telescopic parts of the support 12 in the socket 26 without impairing the height above the ground.

1. A support fitting for height-adjustable support of a substantially horizontally extending bearing and guiding rail, in particular for a camera dolly, comprising a fitting body which,
in the region of a side defined as the upper side, has a bearing surface for directly or indirectly underpinning the rail; and
which, on a side which is defined as the lower side and is opposite the upper side, has receiving and/or fastening means for fixing at least one support element, with which the support fitting can be supported at a certain height in relation to a base.

2. A support fitting for height-adjustable support of a substantially horizontally extending bearing and guiding rail, in particular for a camera dolly, comprising a fitting body which,
on a side defined lower side, has receiving and/or fastening means for fixing at least one support element with which the support fitting can be supported at a certain height in relation to a base, wherein,
for reinforcement purposes, the rail has a bearer, to which the support fitting is fastened or is fastenable outside a vertical plane of the rail.

3. The support fitting as claimed in claim 1, wherein the fitting body has at least one stop means between the upper and lower side for connecting components substantially extending under the bearing surface.

4. The support fitting as claimed in claim 1, wherein, in the event of directly underpinning the rail, the bearing surface is matched to at least one partial region of the rail circumferential contour for surface contact therewith.

5. The support fitting as claimed in claim 1, wherein, in the event of indirectly underpinning the rail, the bearing surface is matched to at least one partial region of a bearer of the rail for surface contact therewith.

6. The support fitting as claimed in claim 1, wherein the lower side of the receiving and/or fastening means lies above the lower side of the rail, a bearer of the rail and/or a tie or is aligned with the lower side of one of the elements mentioned.

7. The support fitting as claimed in claim 1, wherein the longitudinal axis of the receiving and/or fastening means and therefore of the support element substantially extends through the center of gravity of the area of the bearing surface.

8. The support fitting as claimed in claim 1, wherein the receiving and/or fastening means for fixing the support element are designed as a socket, in which the support element can be arranged in such a manner that the longitudinal axis thereof is substantially perpendicular to the bearing surface.

9. The support fitting as claimed in claim 8, wherein clamping means are provided on the socket and can be used to firmly clamp the support element in the socket.

10. The support fitting as claimed in claim 8, wherein the socket has a flap section which is fastened in a hinged manner to the socket via a hinge.

11. The support fitting as claimed in claim 1, wherein the support element is connectable to the receiving and/or fastening means and is adjustable via a screw connection.

12. The support fitting as claimed in claim 1, wherein the stop means are fastening flanges and/or fastening bores.

13. The support fitting as claimed in claim 1, wherein at least three stop means are provided, wherein two of said stop means lie in a plane aligned with a longitudinal axis of the bearing surface and the third stop means is at a right angle thereto.

14. The support fitting as claimed in claim 1, wherein two stop means which are aligned with the longitudinal axis of the bearing surface are fastenable to rail bearers, and in that third stop means which are at a right angle thereto are fastenable to ties which extend between rails extending parallel to each other of a track.

15. A rail system, in particular for a camera dolly, formed from two rails which extend substantially equidistantly from each other and the distance between which is adjusted and maintained by ties extending therebetween, wherein a support fitting as claimed in claim 1 is arranged.
